(19) United States
(12) Patent Application Publication
(10) Pub. No.: US 2015/0233246 A1
(43) Pub. Date: Aug. 20, 2015

(54) STEAM ENGINE ELECTRICITY PRODUCTION ASSEMBLY

(71) Applicant: EXOES, Gradignan (FR)

(72) Inventors: Remi Daccord, Villenave d'Ornon (FR); Thiebaut Kientz, Paris (FR); Basile Gallot, Cadaujac (FR)

(73) Assignee: EXOES, Gradignan (FR)

(21) Appl. No.: 14/429,769

(22) PCT Filed: Sep. 19, 2013
(86) PCT No.: PCT/EP2013/069512

§ 371 Date: Mar. 19, 2015

(30) Foreign Application Priority Data
Sep. 21, 2012 (FR) 1258888

(51) Int. Cl. F01B 17/04; H02K 7/075; H02K 7/18

(52) U.S. Cl. CPC F01B 17/04; H02K 7/1815; H02K 7/075; F01B 2250/005

(57) ABSTRACT

The invention proposes an electricity producing assembly comprising a steam engine coupled to an electric generator (19), the steam engine comprising at least one cylinder (11) and piston (12) assembly (10), a mobile coupling (13) between the cylinder (11) and a drive shaft (14) of the electric generator (10), and a timing device (15) comprising a timing bottom part (16) controlled by a cam mechanism, and a timing top part (17) comprising at least one valve and connected to the bottom part (16) by at least one valve operating stem, and an oil-based lubricating system (201), characterized in that only the timing bottom part (16) is served by the oil-based lubricating system (201).

### FIELD OF THE INVENTION

The invention relates to an electricity producing assembly comprising a steam engine coupled to an electric generator.

### PRIOR ART

Some electricity producing assemblies comprise a steam engine coupled to an electric generator. The engine is coupled to the electric generator via the transmission. Such assemblies are used in particular in the cogeneration of hot water and electricity for buildings, part of the heat produced (by any fuel) being used to produce pressurized steam and to power the assembly so that it produces electricity for local use.

In such assemblies, the engine comprises a piston engine powered by pressurized gas. The piston of the engine is mobile in a cylinder and forms the boundaries of a chamber equipped with an intake and exhaust system.

Such assemblies require the use of a lubricant, such as an appropriate oil.

However, in such assemblies, the mixture of the lubricant and the working fluid poses a problem. Specifically, during operation, part of the lubricant can pass into the working fluid and break down on the hot walls of the evaporator belonging to the assembly, and the working fluid passing into the lubricant can dilute it and thus impair its properties.

Moreover, the use of a lubrication system for the mobile coupling, such as flood lubrication or pressurized lubrication for example, makes the maintenance of such a system complicated and the changing of the piston usually requires the crankcase to be drained.

### General Overview of the Invention

One aim of the invention is to supply an electricity producing assembly, of the type comprising a steam engine coupled to an electric generator, that does not have the aforementioned drawbacks.

For this purpose, provision is made for an electricity producing assembly, comprising a steam engine coupled to an electric generator, the steam engine comprising at least one cylinder and piston assembly, a mobile coupling between the cylinder and a drive shaft of the electric generator, and a distribution device comprising a bottom distribution part controlled by a cam mechanism, and a top distribution part comprising at least one valve and connected to the bottom part by at least one valve operating stem, and an oil-based lubrication system, characterized in that only the bottom distribution part is served by the oil-based lubrication system.

The invention is advantageously completed by the following features, taken alone or in any technically possible combinations:
the mobile coupling is provided in a dry chamber defined by a framework of the assembly, and the bottom distribution part is housed in a lubricated chamber served by the oil-based lubrication system, adjacent to the dry chamber, provision being made for annular sealing means between the two chambers.
the dry chamber has a first window in alignment with each piston, through which the latter can be extracted, and a second window in alignment with the drive shaft of the electric generator, and through which an unbalance crankshaft of the mobile coupling can be extracted.
the dry chamber containing the mobile coupling is equipped with means for recovering steam leaks originating from a working chamber bounded by the cylinder and the piston.
the top distribution part is provided in a dry module removably attached to a cylinder head.
the or each valve stem has a first part passing through a wall of the lubricated chamber via a sealing gasket, and a second part removably connected to the first part and controlling the un-lubricated top distribution part.
the dry chamber and the lubricated chamber are formed from a single framework.

It will be noted that throughout the present document the term “dry chamber” refers to a chamber devoid of a specific lubricant, such a chamber being however able to contain steam, or other components not added for lubrication purposes, during operation.

### BRIEF DESCRIPTION OF THE FIGURES

Other features, aims and advantages of the invention will become apparent upon reading the description of a preferred but non-limiting embodiment below. In the appended drawings:

FIG. 1a represents a kinematic diagram in a side view of an engine of an assembly according to an embodiment of the invention

FIG. 1b represents a kinematic diagram of a piston and a connecting rod in a front view of an engine of an assembly according to an embodiment of the invention,

FIG. 1c represents a kinematic diagram of the distribution in a front view of an engine according to an embodiment of the invention,

FIG. 2 represents an exploded perspective view illustrating the assembling of a mobile coupling of an engine of an assembly according to an embodiment of the invention,

FIG. 3 illustrates the assembling of a top part of the distribution of an engine of an assembly according to an embodiment of the invention.

### DETAILED DESCRIPTION

### Steam Engine

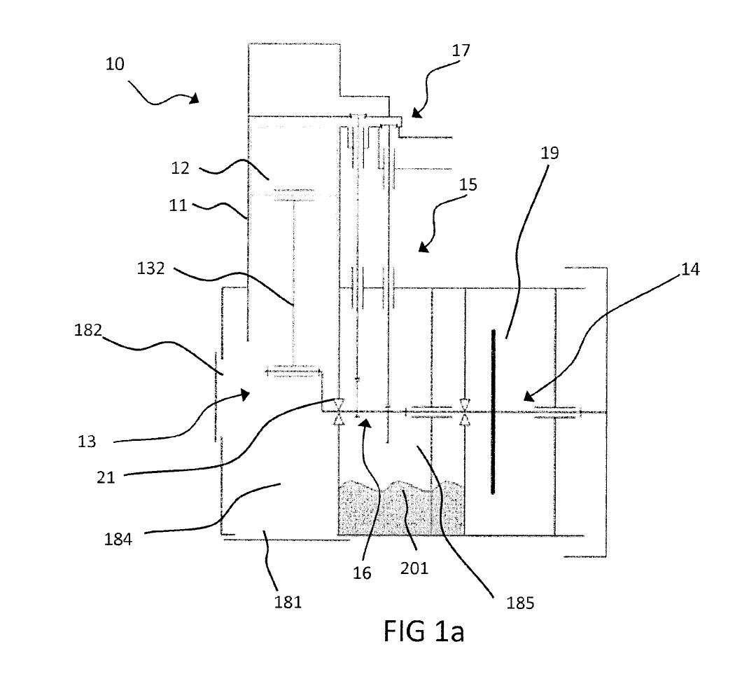

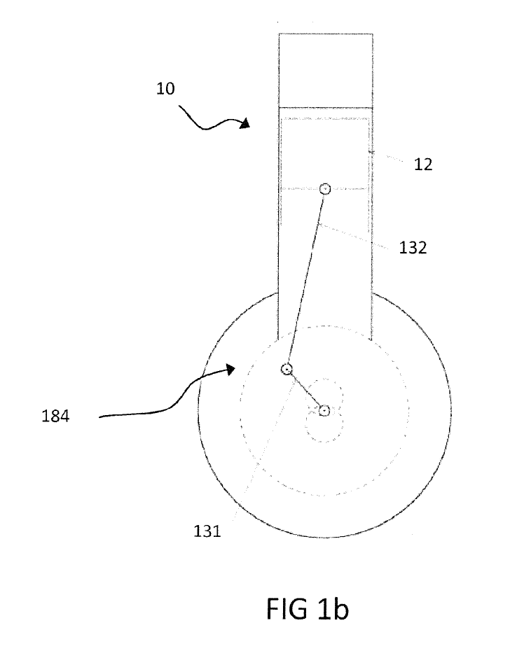

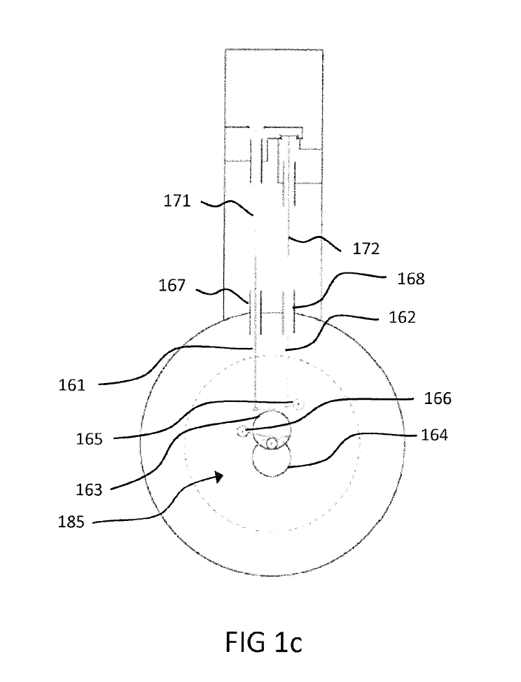

A steam engine is represented with reference to FIGS. 1a, 1b and 1c. This engine is included in an assembly wherein the steam engine is coupled to an electric generator 19 such as an alternator.

The steam engine comprises a cylinder 11 and piston 12 assembly 10. The engine comprises a mobile coupling 13 between the cylinder 11 and a drive shaft 14 of the electric generator.

The engine further comprises a distribution device 15. The distribution device 15 comprises a bottom distribution part 16 controlled by a cam mechanism 163 and 164. The distribution device 15 further comprises a top distribution part 17 comprising at least one valve, and connected to the bottom part 16 by at least one operating stem.

The top part 17 can for example comprise an intake valve 171 connected to the bottom part 16 by at least one intake operating stem 161. The top part 17 can for example comprise an exhaust valve 172 connected to the bottom part 16 by at least one exhaust operating stem 162.

The piston 12 drives the shaft 14 by way of the mobile coupling 13. The mobile coupling 13 comprises an unbalance crankpin 131. Firstly, the unbalance crankpin 131 forms with the shaft 14 a crankshaft in rotation about a drive shaft defined by the shaft 14. Secondly, the unbalance crankpin 131 is in a pivot linkage with a connecting rod 132 at the level of a part forming the crank of the unbalance crankpin 131. Such a connecting rod-and-crank transmission is known to those skilled in the art.

The shaft 14 also drives the distribution device 15 by way of at least one cam, for example an intake operating cam 163 and an exhaust operating cam 164. The intake 163 and exhaust 164 cams are adapted to make an intake 165 and exhaust 166 lever respectively pivot in part about a dedicated pin. The intake 165 and exhaust 166 levers are able to come into contact and rest on the intake 161 and exhaust 162 operating stem respectively, and the rotation of the stems thus makes it possible to alternately open and close the intake 171 and exhaust valve 172 respectively. The cams 163 and 164 are arranged on the drive shaft 4 in such a way that they control the opening and closing of the valves 171 and 172 according to an operating cycle of the engine. Such an operating cycle is known to those skilled in the art and will not be detailed here.

### Lubricated Area and Recovery of Steam Leaks in the Dry Chamber

An oil-based lubrication system 201 of an isolated lubricated area 185 of the assembly is described.

The bottom part 16 of the distribution 15 is housed in the lubricated chamber 185, adjacent to the dry chamber 184.

Annular sealing means 21 are provided, particularly between the two chambers 184 and 185, around the shaft 14.

The dry chamber 184 and the lubricated chamber 185 are for example made of a single framework.

An aperture 20 is made in the bottom of the dry chamber to allow the drainage of steam condensate and its recovery.

### Connecting Rod-Crankshaft Connection

Assembling of the Mobile Coupling

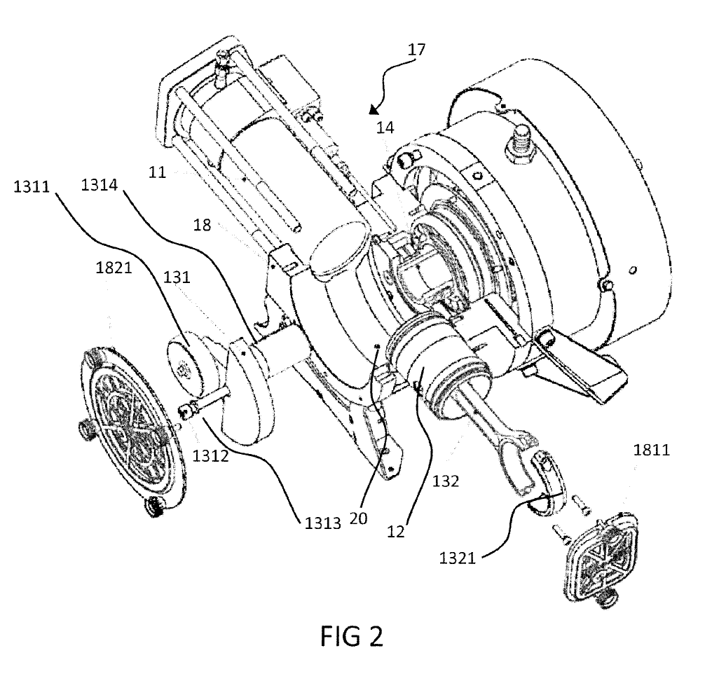

The assembling of the mobile coupling 13 is described with reference to FIG. 2.

The mobile coupling 13 is provided in a dry chamber 184 defined by a framework of the assembly and having a first window 181 in alignment with the piston 12, through which the latter can be extracted, and a second window 182 in alignment with the drive shaft 14 of the electric generator, and through which an unbalance crankshaft assembly 131 of the mobile coupling 13 can be extracted.

A first step consists in replacing the mobile coupling 13 through the windows 181 and 182 of a crankcase 18. The piston 12 and the connecting rod 132 are inserted through the first window 181 and arranged along the cylinder 10. The connecting rod 132 has a cap 1321 at the end opposite the piston 12. This cap 1321 forms an arch and is adapted to be screwed to the connecting rod 132, the ends of the arch of the cap 1321 being screwed at the ends of a part of the connecting rod 132 forming an arch of a substantially identical shape to form a circular aperture. In this step, the cap 1321 is unscrewed. The unbalance crankpin 131 is then inserted through the first window 181 along the drive shaft. The connection between the unbalance crankpin 131 and the shaft 14 is ensured by way of a connecting screw 1312 and a washer 1313 arranged at the level of the drive shaft, the head of the connecting screw 1312 in position being arranged at the level of one side of the unbalance crankpin 131 facing the first window 181, and the connecting screw 1312 passing through the unbalance crankpin 131 to open onto an aperture of the shaft 14 at the level of which it is screwed. The unbalance crankpin 131 is further connected to the shaft 14 by keys 1314.

A second step consists in fixing the connecting rod 132 to the unbalance crankpin 131. The cap 1321 is placed in such a way that a bearing 1311 of the crank of the unbalance crankpin 131 is arranged at the level of the arch of the connecting rod 132. The cap 1321 is then screwed to the connecting rod 132 to clamp the bearing 1311 in the circular aperture thus formed. The bearing 1311 is for example a ball bearing.

Disassembling

Disassembling of the mobile coupling 13 is achieved using disassembly methods symmetrical to the described assembling methods.

Thus, the mobile coupling 13 is arranged in a non-lubricated part of the engine, in the dry chamber 184.

In particular, the assembly forming the crankshaft is not lubricated. A non-lubricated part of an engine must in general undergo more frequent maintenance.

Maintenance of the mobile coupling 13 is easy here because the structure of the engine and the methods described allow for quick assembling and disassembling of the mobile coupling 13 as described previously.

### Distribution

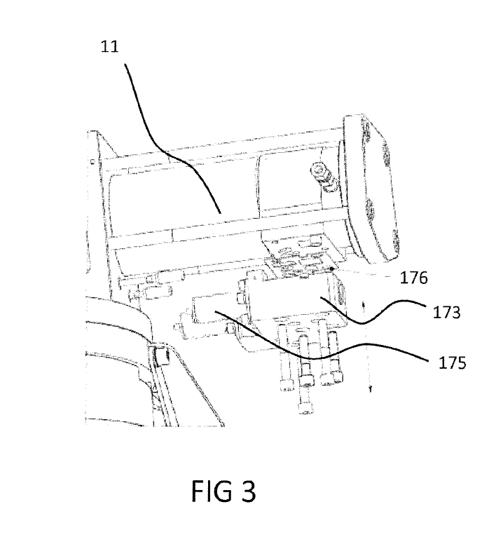

The structure of the distribution 15 is described with reference to FIGS. 1c and 3.

The valves 171 and 172 are each inserted into an aperture of a valve lift 173. Apart from the valve lift 173, the valves 171 and 172 are held by dedicated supports 175, engaged with the valve lift 173, for example each screwed to the valve lift 173, and extending around the section of the corresponding valve which extends out of the valve lift. A valve lift gasket 176, for example in the form of a drilled plate, ensures the sealing at the exit of the apertures of the valve lift 173. The intake valve 171 and exhaust valve 172 are mechanically connected to the intake 161 and exhaust 162 valve operating stem respectively.

Thus the top distribution 15 part 17 is provided in a dry module removably attached to a cylinder 11 head.

The operating stem passing through a wall of the lubricated chamber 185 via an operating stem sealing gasket comprising a dedicated guide, insert and gasket is removably connected to the top distribution part 17.

For example, the intake 161 and exhaust 162 operating stems crossing a wall of the lubricated chamber 185 via, respectively, an intake 161 and exhaust 162 operating stem sealing gasket 167 and 168 comprising a dedicated guide, insert and gasket, can be removably connected to the intake 171 and 172 valve respectively, thus controlling the top distribution part 17.

The intake 165 and exhaust 166 levers and the intake 163 and exhaust 164 cams are arranged in the lubricated chamber 185 while the intake 171 and exhaust 172 valves are arranged outside the lubricated chamber 185. The valve lift 173 and the valves 171 and 172 are in open air and in contact with the steam. Thus, only the bottom distribution 15 part 16 is served by the oil-based lubrication system 201. The bottom part 16 and the top part 17 of the distribution are sealingly separated. Maintenance of each of the two parts can therefore be carried out independently of the other part.

The assembly makes it possible to limit the mixing of the lubricant and the working fluid of the engine, or even to completely prevent any risk of mixing the lubricant and the working fluid by restricting the lubricated area to the bottom part 16 of the distribution control. The sealing means between the non-lubricated and lubricated areas are thus limited and maintenance is simplified, the mobile coupling 13 and the top distribution part 17 being able to be quickly changed independently of the bottom part 16 and of the lubricated area.

Of course, the present invention is in no way limited to the form of embodiment described and represented, but those skilled in the art will be able to contribute many variants and improvements.

In particular, even if the form of embodiment described here is particularly applicable to a steam engine equipped with a single cylinder, the invention is also applicable to other steam engine architectures such as a V-twin engine architecture.

1. An electricity-producing assembly, comprising a steam engine coupled to an electric generator, the steam engine comprising at least one cylinder and piston assembly, a mobile coupling between the cylinder and a drive shaft of the electric generator, and a distribution device comprising a bottom distribution part controlled by a cam mechanism and a top distribution part comprising at least one valve and connected to the bottom part by at least one valve operating stem and an oil-based lubrication system, wherein only the bottom distribution part is served by the oil-based lubrication system.

2. The assembly according to claim 1, wherein provision is made for the mobile coupling in a dry chamber defined by a framework of the assembly, and the bottom distribution part is housed in a lubricated chamber served by the oil-based lubrication system, adjacent to the dry chamber, provision being made for annular sealing means between the two chambers.

3. The assembly according to claim 2, wherein the dry chamber has a first window in alignment with each piston, through which the latter can be extracted, and a second window in alignment with the drive shaft of the electric generator, and through which an unbalance crankshaft of the mobile coupling can be extracted.

4. The assembly according to claim 2, wherein the dry chamber containing the mobile coupling is equipped with means for recovering steam leaks originating from a working chamber bounded by the cylinder and the piston.

5. The assembly according to claim 1, wherein the top distribution part is provided in a dry module removably attached to a cylinder head.

6. The assembly according to claim 2, wherein the or each valve operating stem passes through a wall of the lubricated chamber via a sealing gasket, and is removably connected to the un-lubricated top distribution part.

7. The assembly according to claim 2, wherein the dry chamber and the lubricated chamber are formed from a single framework.
